(19) United States
(12) Patent Application Publication
(10) Pub. No.: US 2018/0025112 A1
(43) Pub. Date: Jan. 25, 2018

(54) MEDICAL INFORMATION PROCESSING SYSTEM AND MEDICAL INFORMATION PROCESSING METHOD

(71) Applicant: TOPCON CORPORATION, ltabashi-ku (JP)

(72) Inventor: Noriyasu TAKEDA, Taitou-ku (JP)

(73) Assignee: TOPCON CORPORATION, ltabashi-ku (JP)

(21) Appl. No.: 15/642,724

(22) Filed: Jul. 6, 2017

(30) Foreign Application Priority Data
Jul. 22, 2016 (JP) 2016-144881

(51) Int. Cl. G06F 19/00; G06N 3/00

(52) U.S. Cl. CPC G06F 19/321; G06F 19/345; G06N 3/004

(57) ABSTRACT

An aspect of a medical information processing system according to an exemplary embodiment includes an artificial intelligence engine that processes medical information based on a database. The medical information processing system includes a reception unit, first classification processor, selection processor, and second classification processor. The reception unit receives medical information comprising a medical image. The first classification processor classifies, based on the database, the medical image into a category among two or more categories set in advance. The selection processor selects a category among the two or more categories based on the medical information. The second classification processor classifies the medical image into a singular category when the category determined by the first classification processor and the category determined by the selection processor do not agree with one another.

### CROSS-REFERENCE TO RELATED APPLICATION

This application is based upon and claims the benefit of priority from Japanese Patent Application 2016-144881, filed Jul. 22, 2016; the entire contents of which are incorporated herein by reference.

### BACKGROUND

Diagnostic imaging and image analysis are important in various medical field. For example, in ophthalmology, slit lamp microscopes, fundus cameras, scanning laser ophthalmoscopes (SLO), optical coherence tomography (OCT) apparatuses, laser speckle flowgraphy (LSFG) apparatuses, surgical microscopes, and the like are utilized.

Some imaging apparatuses can be used for a plurality of imaging modalities. For example, fundus cameras are used for infrared observation, color photography, fluorescein angiography, indocyanine green angiography, autofluorescence photography, red reflex photography, and the like. In addition, OCT apparatuses are used for morphology imaging such as B scan and volume scan, angiography, blood flow measurement, polarization imaging, and the like. In addition, many ophthalmic apparatuses other than imaging apparatuses (e.g., examination apparatuses, measurement apparatuses) have a function of acquiring moving images using infrared light for observing subject's eyes.

In medical fields other than ophthalmology, various imaging apparatuses are utilized such as X-ray diagnostic apparatuses, X-ray computed tomography (CT) apparatuses, magnetic resonance imaging (MRI) apparatuses, positron emission tomography (PET) apparatuses, single photon emission computed tomography (SPECT) apparatuses, endoscopes, and the like.

Images acquired by imaging apparatuses are used for medical screening, lesion detection or the like. For medical follow-up, pre- and post-operative observation, or the like, a plurality of images acquired at different times are used for cooperative observation, cooperative analysis, or the like.

In recent years, the advance of artificial intelligence technology has been remarkable, and the application to medical fields has been progressed. The application covers a wide range of medical fields such as decision making support, data analysis, data mining, transaction (e.g., electronic health record systems, ordering systems, medical accounting systems), image processing, image analysis, robots, genetic analysis, and the like.

Examples of conventional artificial intelligence technology are disclosed in Japanese Unexamined Patent Application Publication No. 2007-195994 and Japanese Unexamined Patent Application Publication No. 2015-028791.

Effective use of artificial intelligence requires proper learning. In the medical application of artificial intelligence, it is desirable to use not only character string information (text information) included in electronic medical records but also medical images.

Various kinds of information acquired by history taking, consultation, examination, imaging and the like is considered in a comprehensive way for diagnosis and treatment. Therefore, there are cases where image findings or image analysis results do not agree with diagnosis result. For example, there is a case in which findings understood from OCT images of eye fundus, the thickness of the retinal nerve fiber layer (RNFL), or the like do not correspond to typical examples of glaucoma, although a final diagnosis “glaucoma” is given based on the result of visual field test, tonometry, and the like. On the other hand, there is a case in which thinning of RNFL, which is typical findings of glaucoma, is caused by other factors such as excessive myopia.

In addition, there are cases where findings understood from images acquired by one modality and findings understood from images acquired by another modality do not correspond to each other. For example, the morphology of the optic nerve head understood from a fundus image corresponds to typical findings of glaucoma while findings understood from a fundus OCT image, RNFL thickness, or the like do not correspond to typical findings of glaucoma.

Such events can cause deterioration of precision and accuracy of reasoning, data mining, or the like performed by artificial intelligence.

### BRIEF SUMMARY

An exemplary aspect of a medical information processing system of an embodiment includes an artificial intelligence engine that processes medical information based on a database. The medical information processing system includes a reception unit, a first classification processor, a selection processor, and a second classification processor. The reception unit is configured to receive medical information comprising a medical image. The first classification processor is configured to classify, based on the database, the medical image into a category among two or more categories set in advance. The selection processor is configured to select a category among the two or more categories based on the medical information. The second classification processor is configured to classify the medical image into a singular category when the category determined by the first classification processor and the category determined by the selection processor do not agree with one another.

An exemplary aspect of a medical information processing method of an embodiment is performed using a computer including an artificial intelligence engine that executes processing based on a database. The computer receives medical information comprising a medical image. The computer classifies, based on the database, the medical image into a category among two or more categories set in advance. The computer selects a category among the two or more categories based on the medical information. The computer classifies the medical image into a singular category when the category into which the medical image is classified and the category selected based on the medical information do not agree with one another.

### BRIEF DESCRIPTION OF THE DRAWINGS

FIG. 1 is a flow chart illustrating an exemplary medical information processing method.

FIG. 2 is a schematic diagram illustrating the configuration of an exemplary medical information processing system.

FIG. 3 is a schematic diagram illustrating the configuration of an exemplary medical information processing system.

### DETAILED DESCRIPTION

Exemplary embodiments of the present invention will be described in detail with referring to the drawings. Exemplary medical information processing methods can be realized with exemplary medical information processing systems. An exemplary medical information processing system includes a database and an artificial intelligence engine.

An exemplary medical information processing system is installed in a medical institution, a research institution, or the like, and used by doctors, researchers, or the like. Another exemplary medical information processing system may include a server, a database, and the like accessible from a plurality of medical institutions, research institutions, or the like. An exemplary medical information processing system may be constructed using various kinds of computing technology such as grid computing, cloud computing, parallel computing, distributed computing, or the like.

A database stores, for example: known information such as technical books, specialized books, essays, treatises, monographs, theses, dissertations, articles, and papers; medical information acquired in medical institutions and the like; and various kinds of medical knowledge. Based on the database, an artificial intelligence engine can execute machine learning, data mining, reasoning (or inference), statistical processing, and the like. Medical knowledge acquired by the artificial intelligence engine can be stored in the database. The accuracy and precision of the processing executed by the medical information processing system can be improved by updating the database and/or updating the artificial intelligence engine (e.g., updating a parameter etc.) by the use of machine learning or the like.

Any kinds of machine learning technology can be applied to embodiment. For example, any of supervised learning, unsupervised learning, semi-supervised learning, reinforcement learning, transduction (or transductive inference), and multi-task learning may be applied to embodiments. In addition, it is possible to adopt any kinds of machine learning techniques such as decision tree learning, association rule learning, neural network, genetic programming, inductive logic programming, support vector machine, clustering, Bayesian network, or feature learning (or representation learning). Further, any kinds of information processing technology such as natural language processing, image processing, automated reasoning, or data mining can be utilized for machine learning.

The natural language processing may include any kinds of known technology such as morphological analysis, syntactic analysis (or parsing), context analysis, semantic understanding, word-sense disambiguation, reference resolution, latent semantic analysis, or the like. Any kinds of application technology of natural language processing can be applied to natural language information. For example, automatic summarization, information extraction, information retrieval, concept search, machine translation, named entity extraction (or named entity recognition), natural language generation, proofreading, spell checker, or the like can be adopted. In addition to such natural language processing and/or its application technology, data clustering, document classification (or document categorization), or the like can be adopted.

The image processing may include any kinds of processing such as correction, transformation, analysis, or any combination thereof. Examples of the correction include brightness correction, color correction, contrast correction, edge detection, detection of a site, evaluation of a site, detection of a lesion, evaluation of a lesion, detection of lesion distribution, evaluation of lesion distribution, detection of morphology, evaluation of morphology, measurement of size, evaluation of size, measurement of function information, evaluation of function information, elapse analysis (or time series analysis), inference of disease name (or specification of possible disease), and the like. The image processing may include at least one of analysis of still images and analysis of moving images.

Knowledge, for example, includes information that can be recognized and explicit representation, and includes at least one of empirical knowledge (i.e., knowledge acquired through experience or education) and theoretical knowledge (i.e., theoretical background knowledge or systems of technical information). Typical examples of such knowledge include facts, rules, laws, principles, criterions, common knowledge, common practices, common senses, know-hows, dictionaries, corpora, and the like. Knowledge may include information related to processing executed by the artificial intelligence engine. For example, knowledge may include weight parameters and bias parameters for a neural network. In the present embodiment, medical knowledge is taken into consideration.

The medical information processing system of a typical embodiment at least includes one or more computers (including an artificial intelligence engine) and one or more storage devices (configuring at least part of the database).

The medical information processing system can communicate with various kinds of external devices (e.g., computers, computer systems, medical apparatuses). For example, the medical information processing system can communicate with a computer that is installed in a medical institution or a research institution, and receives medical information of patients and the like through a communication line.

The communication system between the medical information processing system and the external devices is of an arbitrary type. For example, the communication system between the medical information processing system and the external devices may include wired communication and/or wireless communication, may include a private line and/or a public line, and may include at least one of a local area network (LAN), a wide area network (WAN), near field communication, and the internet.

Hardware and software for implementing the computer included in the present embodiment are not limited to those described below. Also, Hardware and software for implementing the medical information processing system, apparatus, and method are not limited to those described below. Arbitrary combination of any hardware and any software for the implementation can be included.

The medical information processing system includes hardware and software that function as an artificial intelligence engine and hardware and software that function as a database utilized by the artificial intelligence engine. The artificial intelligence engine includes, for example, a system constructed by the use of artificial intelligence technology, a system constructed by the use of cognitive computing technology, or the like.

### <Examples of Medical Information Processing Methods>

In the present example, the processes of the medical information processing method are executed by a computer. The computer includes an artificial intelligence engine. The computer includes one or more processors. The processor includes a circuit such as a central processing unit (CPU), a graphics processing unit (GPU), an application specific integrated circuit (ASIC), a programmable logic device (e.g., simple programmable logic device (SPLD), complex programmable logic device (CPLD)), a field programmable gate array (FPGA), or the like. The processor is configured, for example, to read out a computer program from a storage device (or a storage circuit), and to execute the computer program, thereby performing a desired function.

The processor can control the storage device and/or an output device. The storage device may be included in the computer or may be arranged outside the computer. Similarly, the output device may be arranged in or outside the computer. The output device is a device for outputting information. A typical example of the output device is a display device, a communication device, an audio output device, a printer, a data writer, or the like.

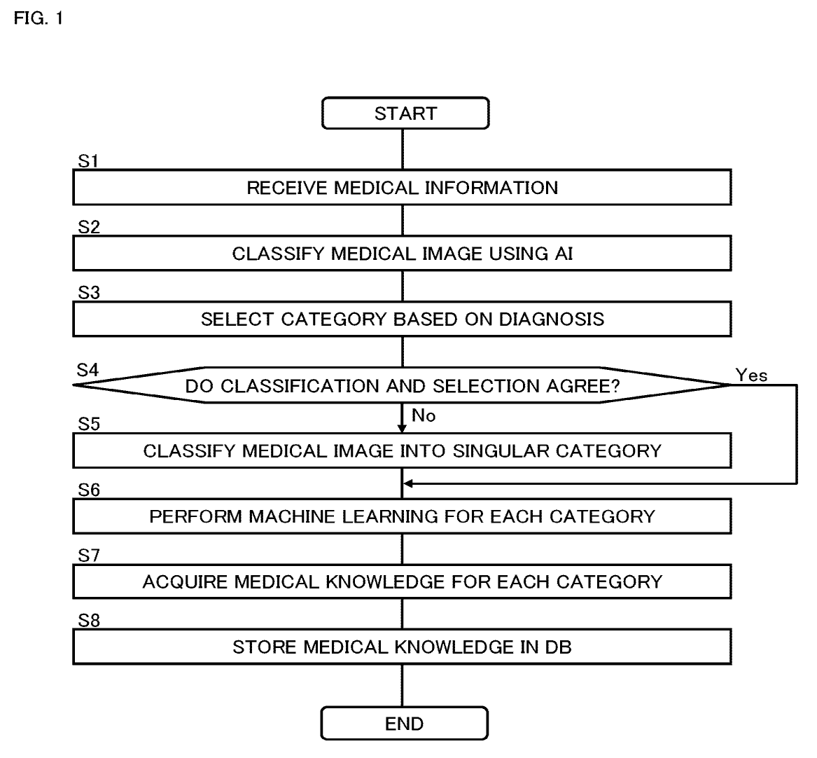

FIG. 1 shows an example of the medical information processing method including an exemplary embodiment. The processes shown in FIG. 1 is merely an example, and one or more steps therein are optional. In other words, there is no need for a medical information processing method according to arbitrary embodiment to include all the steps shown in FIG. 1. Such a medical information processing method according to arbitrary embodiment may include only part of the steps shown in FIG. 1.

Prior to the commencement of the processes shown in FIG. 1, the following procedure or processes are performed, for example. An administrator of the medical information processing system etc. makes a contract with a medical institution, a research institution, or the like to receive the provision of medical information of patients (e.g., electronic health records, medical images, examination data, genetic data), medical knowledge, and the like

The contract may include any kinds of terms such as types of medical information to be provided. Typical examples of the terms of the contract include the provision of medical information acquired in a specific specialty (or specific department), the provision of medical information related to a specific disease, the provision of medical information from a specific doctor or a specific researcher, and the like.

### (S1: Receive Medical Information)

The medical information processing system receives medical information from the medical institute etc. The medical information processing system may include a communication device that receives the medical information transmitted from the medical institute etc. The medical information processing system may include a data reader that reads out the medical information recorded in a recording medium.

The medical information may be prepared in the form of a package including information acquired for a single patient (e.g., electronic health record, medical images, examination data, genetic data of the patient), for example. Medical information of another example may be prepared in the form of a package including information acquired for a plurality of patients of a specific disease name (e.g., final diagnosis result, possible disease name). Other than them, exemplary medical information may be prepared in the form of a package including information acquired in one or more specialties, or may be prepared in the form of a package including information acquired in one or more institutions.

The medical information includes a medical image(s). The medical image is acquired with any kind of modality. For example, in ophthalmology, a slit lamp microscope, a fundus camera, an SLO, an OCT apparatus, an LSFG apparatus, a surgical microscope, and the like are used for acquiring an image of the patient's eye. In addition, examples of imaging methods (or modalities) include: infrared observation, color photography, fluorescein angiography, indocyanine green angiography, autofluorescence photography, and red reflex photography with the fundus camera; and morphology imaging, angiography, blood flow measurement, and polarization imaging with the OCT apparatus. In radiology, an X-ray diagnostic apparatus, an X-ray CT apparatus, an MRI apparatus, a PET apparatus, a SPECT apparatus, and the like are used. In various departments, an ultrasonic diagnostic apparatus, an endoscope, and the like are used.

The medical information includes information for the selection of category described later (see the step S3). A typical example of such information is a disease name (e.g., final diagnosis result, possible disease name). the disease name has been entered in an electronic health record and the like. In another example, the selection of category may be carried out based on examination data that is considered to be more important than a medical image in diagnosis. For instance, in diagnosis of glaucoma, there are cases where the result of visual field test and/or an intraocular pressure value are/is considered to be more important than an OCT image.

The medical information processing system or the computer installed in the medical institute etc. may be configured to process information of a predetermined item included in the medical information. The information of a predetermined item includes, for example, personally identifiable information (e.g., name, address, patient ID, social insurance number) of patients. Typical examples of the processes of the personally identifiable information include deletion, encryption, abstraction, and the like. As an example of the abstraction, the actual age of a patient is transformed into a corresponding age bracket (or, age segment or age group). Specifically, actual age “35” may be transformed into “30s”, or into “40” by rounding off.

### (S2: Classify Medical Image Using Artificial Intelligence)

The artificial intelligence engine classifies the medical image included in the medical information received in the step S1 based on the database in which known information, medical information, medical knowledge, etc. has been stored. For the classification, the artificial intelligence engine determines (or selects) a category to which the medical image belongs from among two or more categories set in advance.

For example, a “suspicious” category indicating that there is suspicion of a specific disease (e.g., glaucoma) and an “unsuspicious” category indicating that there is no suspicion of the specific disease can be prepared. In another example, two or more categories indicating degrees of progression (i.e., degrees of severity) of a specific disease can be prepared. In yet another example, two or more categories based on features or characteristics acquired through analysis or medical images or the like can be prepared.

Specific examples will be described. The artificial intelligence engine processes an OCT image of eye fundus included in the medical information received in the step S1 to determine whether the OCT image belongs to the “suspicious” category or the “unsuspicious” category for glaucoma. Note that an “unknown” category can be prepared for the cases where the presence or absence of glaucoma (or the suspicion thereof) cannot be determined. For example, the artificial intelligence engine may be configured to reason (or infer) whether the OCT image matches with a general case, a typical case, a general finding a typical finding, or the like based on the database including a knowledge base on glaucoma. In the reasoning process, for example, the artificial intelligence engine or other processor acquires, from the OCT image, features or characteristics referred to in the diagnosis of glaucoma such as the thickness distribution of RNFL, the morphology of the optic nerve head, morphology of the lamina cribrosa, or the like. In addition, the artificial intelligence engine compares the acquired features or characteristics with the knowledge base.

In another example, the artificial intelligence engine may be configured to process the OCT image based on a similar knowledge base to determine whether the OCT image belongs to the “severe glaucoma” category, the “moderate glaucoma” category, or the “mild glaucoma” category. In addition, the “unknown” category can be prepared for the cases where the degrees of progression cannot be determined.

### (S3: Select Category Based on Diagnosis)

The medical information processing system (e.g., the artificial intelligence engine or other processor) selects a category from the two or more categories that are options in the step S2 based on a predetermined information included in the medical information (e.g., information other than image data such as the disease name determined by diagnosis, examination data, or the like).

Specific examples will be described. When the medical information includes the electronic health record in which the disease name (e.g., final diagnosis result, possible disease name) has been entered, the medical information processing system can select a category corresponding to the disease name. For example, when the “suspicious” category and the “unsuspicious” category for glaucoma are options in the step S2, the “suspicious” category is selected if the disease name includes glaucoma and the “unsuspicious” category is selected if the disease name does not include glaucoma

(S4: Do Classification and Selection Agree with One Another?)

The medical information processing system (e.g., the artificial intelligence engine or other processor) determines whether the category into which the medical image is classified in the step S2 and the category selected in the step S3 agree with one another. When these categories agree with each other (S4: Yes), the procedure moves on to the step S6. On the other hand, when these categories do not agree with each other (S4: No), the procedure moves on to the step S5.

(S5: Classify Medical Image into Singular Category)

When it is determined that the two categories do not agree with each other (S4: No), the medical information processing system (e.g., the artificial intelligence engine or other processor) classifies the medical image into a singular category. The singular category is a category that is assigned to an exceptional (or singular) medical image that has not been classified into a proper category in the step S2 executed by the artificial intelligence engine. More specifically, the singular category is a category into which a medical image is classified such that the finding of the medical image or the analysis result of the medical image does not agree with the disease name, the examination data, or the like.

When the medical image is classified into the singular category, the result of classification in the step S2 can be discarded. In another example, when the medical image is classified into the singular category, the result of classification in the step S2 can be recorded.

### (S6: Perform Machine Learning for Each Category)

By executing the above processes on a plurality of medical images, medical images are accumulated for each of the categories. For each category, the medical information processing system executes machine learning of the artificial intelligence engine based on medical images belonging to the concerned category.

Note that, as mentioned above, the machine learning is executed with any technology such as supervised learning, unsupervised learning, semi-supervised learning, reinforcement learning, transduction (or transductive inference), multi-task learning, decision tree learning, association rule learning, neural network, genetic programming, inductive logic programming, support vector machine, clustering, Bayesian network, feature learning (or representation learning), or the like.

Specific examples will be described. When the options of categories for glaucoma are the “suspicious” category, the “unsuspicious” category, and the singular category, the medical information processing system executes machine learning of the artificial intelligence engine using medical images belonging to the “suspicious” category, machine learning of the artificial intelligence engine using medical images belonging to the “unsuspicious” category, and machine learning of the artificial intelligence engine using medical images belonging to the singular category.

The medical images classified into the singular category are exceptional (or singular) images such that diagnosis is difficult only with the findings of images, image analysis or the like. For example, by performing the machine learning using the medical images belonging to the singular category in addition to the machine learning based on the “suspicious” category and the machine learning based on the “unsuspicious” category, it becomes possible to improve (or enhance) not only classificatory criteria for medical images that indicate typical findings or typical analysis results for a concerned disease and classificatory criteria for medical images that do not indicate the typical findings or the typical analysis results for the concerned disease, but also classificatory criteria for exceptional medical images. As a result, the accuracy and the precision of the classification process in the step S2 (classification of medical images) carried out in the future are improved.

### (S7: Acquire Medical Knowledge for Each Category)

The medical information processing system (e.g., the artificial intelligence engine) acquires medical knowledge based on the medical images belonging to each category. The process of medical knowledge acquisition may include data mining, reasoning, or the like.

Specific examples will be described. When the options of categories for glaucoma are the “suspicious” category, the “unsuspicious” category, and the singular category, the artificial intelligence engine executes acquisition of medical knowledge based on the medical images belonging to the “suspicious” category, acquisition of medical knowledge based on the medical images belonging to the “unsuspicious” category, and acquisition of medical knowledge based on the medical images belonging to the singular category.

As mentioned above, the medical images classified into the singular category are exceptional (or singular) images such that diagnosis is difficult only with the findings of images, image analysis or the like. Hence, for example, by performing the knowledge acquisition from the medical images belonging to the singular category in addition to the knowledge acquisition based on the “suspicious” category and the knowledge acquisition based on the “unsuspicious” category, it becomes possible to acquire knowledge (features, characteristics, etc.) on medical images that indicate typical findings or typical analysis results for a concerned disease and knowledge (features, characteristics, etc.) on medical images that do not indicate the typical findings or the typical analysis results for the concerned disease, but also knowledge (features, characteristics, etc.) on exceptional medical images.

### (S8: Store Medical Knowledge in Database)

The medical information processing system stores the medical knowledge acquired in the step S7 in the database. The medical knowledge stored in the database can be used for the process of the step S2 (classification of medical images), the process of the step S6 (machine learning), the process of the step S7 (acquisition of medical knowledge), or the like. In addition, the acquired knowledge can be given to medical institutions or the like. This terminates the description of the present example.

### <Examples of Medical Information Processing Systems>

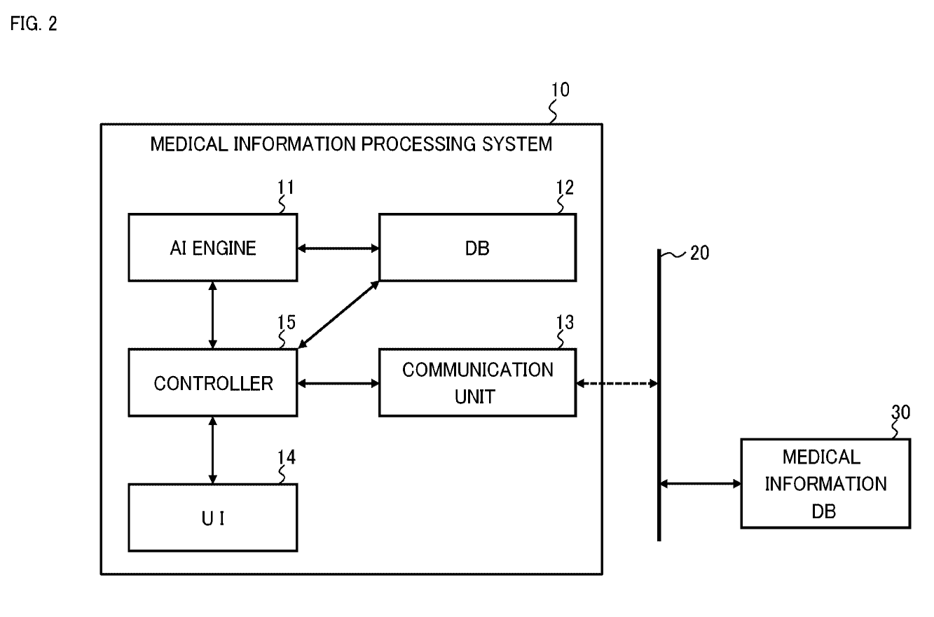

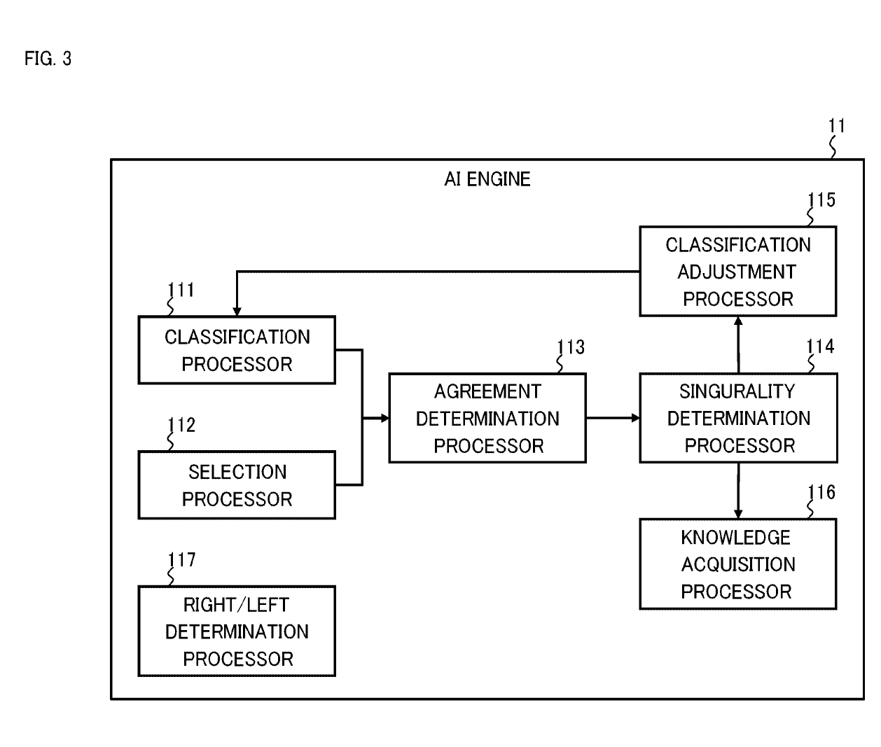

A system for implementing the medical information processing method described above will be described. FIGS. 2 and 3 show an example of the configuration of an exemplary medical information processing system.

The medical information processing system 10 includes the artificial intelligence engine 11 that executes processing based on the database 12. The medical information processing system 10 can communicate with one or more medical information database 30 via the communication line 20. The medical information database 30 is installed in a medical institution or a research institution. Various kinds of medical information (e.g., medical information of patients, research data, or the like) is accumulated in the medical information database 30. The medical information database 30 may be configured to transmit medical information to the medical information processing system 10 in response to a request from the medical information processing system 10. In another example, the medical information database 30 may be configured to transmit medical information to the medical information processing system 10 regularly or irregularly.

In addition to the artificial intelligence engine 11 and the database 12, the medical information processing system 10 includes the communication unit 13, the user interface (UI) 14, and the controller 15.

The database 12 stores, for example, known information such as technical books, specialized books, essays, treatises, monographs, theses, dissertations, articles, and papers, medical information acquired in medical institutions and the like, and various kinds of medical knowledge. Based on the database 12, the artificial intelligence engine 11 can execute machine learning, data mining, reasoning (or inference), statistical processing, and the like. Medical knowledge acquired by the artificial intelligence engine 11 can be stored in the database 12. The accuracy and precision of the processing executed by the medical information processing system 10 can be improved by updating the database 12 and/or updating the artificial intelligence engine 11 by the use of machine learning or the like. Here, the techniques of the machine learning that can be executed by the medical information processing system 10 may be any of the techniques mentioned above or any combination of two or more techniques. The artificial intelligence engine 11 may be configured to execute natural language processing, image processing, reasoning, data mining, and the like.

The communication unit 13 performs processing of sending data to other systems or other apparatuses via the communication line 20 and processing of receiving data from other systems or other apparatuses via the communication line 20. The communication unit 13 includes a known communication device according to the communication system (or communication method) of the communication line 20. The communication unit 13 (and the controller 15) functions as an example of the reception unit that receives medical information including a medical image(s) from the medical information database 30.

The user interface 14 includes a display device and n operation device. The operation device includes, for example, any of a mouse, a keyboard, a trackpad, a button, a key, a joystick, and an operation panel. The user interface 14 may include a touch panel. The user interface 14 may be a computer (e.g., a computer terminal, a mobile terminal) that can be used by a user such as a doctor.

The controller 15 executes various kinds of control. The controller 15 executes control of each component of the medical information processing system 10 and linkage control (or interlock control) of two or more components. For example, the controller 15 controls the communication unit 13 to transmit a request for sending medical image toward the medical information database 30.

The controller 15 can execute control of an external apparatus installed outside the medical information processing system 10. For example, when the user interface 14 is not included in the medical information processing system 10, the controller 15 can executes control of the user interface 14. The controller 15 includes a computer program for executing various kinds of control and a processor that operates according to the computer program.

FIG. 3 shows the configuration of the exemplary artificial intelligence engine 11. The artificial intelligence engine 11 of the present embodiment includes the classification processor 111, the selection processor 112, the agreement determination processor 113, the singularity determination processor 114, the classification adjustment processor 115, knowledge acquisition processor 116, and the right/left determination processor 117.

Note that the artificial intelligence engine 11 need not include all these components. Any of these components can be included in a processor other than the artificial intelligence engine 11.

Based on the database 12, the classification processor 111 classifies the medical image into a category among the two or more categories set in advance. The process of the step S2 in FIG. 1 can be implemented by the classification processor 111. The classification processor 111 functions as an example of the first classification processor.

Based on the medical information (e.g., information other than image data), the selection processor 112 selects a category from among the two or more categories. The medical information referred to for the purpose of the selection of category is, for example, a disease name, examination data that is considered to be more important than a medical image in diagnosis. The process of the step S3 in FIG. 1 can be implemented by the selection processor 112. The selection processor 112 functions as an example of the selection processor.

The agreement determination processor 113 determines whether or not the category determined by the classification processor 111 and the category selected by the selection processor 112 agree with each other. The process of the step S4 in FIG. 1 can be implemented by the agreement determination processor 113.

The singularity determination processor 114 classifies the medical image into the singular category when the agreement determination processor 113 determines that the category determined by the classification processor 111 and the category selected by the selection processor 112 do not agree with each other. The process of the step S5 in FIG. 1 can be implemented by the singularity determination processor 114. The singularity determination processor 114 functions as an example of the second classification processor.

Based on the medical images that have been classified into the singular category by the singularity determination processor 114, the classification adjustment processor 115 adjusts an operation parameter of the classification processor 111. More specifically, the classification adjustment processor 115 executes machine learning of the artificial intelligence engine 11 for medical image classification. In a typical example, the classification processor 111 may include a neural network and the operation parameter may include a weight parameter, a bias parameter, or the like. The process of the step S6 in FIG. 1 can be implemented by the classification adjustment processor 115. The classification adjustment processor 115 functions as an example of the classification adjustment processor.

The classification adjustment processor 115 may be configured to separately execute the machine learning based on the medical images that have been classified into the singular category by the singularity determination processor 114 (referred to as singular images) and the machine learning based on other medical images (referred to as normal images). For example, the classification adjustment processor 115 determines a first value of the operation parameter of the classification processor 111 based on the singular images. In addition, the classification adjustment processor 115 determines a second value of the operation parameter of the classification processor 111 based on the normal images. When the normal images are classified into two or more categories, the classification adjustment processor 115 can determine a value of the operation parameter for each of the two or more categories.

The knowledge acquisition processor 116 acquires medical knowledge based on a plurality of medical images that have been classified into the singular category by the singularity determination processor 114. The knowledge acquisition processor 116 can execute processing such as data mining, reasoning, and the like. The process of the step S7 in FIG. 1 can be implemented by the knowledge acquisition processor 116. The knowledge acquisition processor 116 functions as an example of the knowledge acquisition processor.

The knowledge acquisition processor 116 may be configured to separately execute the knowledge acquisition based on the medical images that have been classified into the singular category by the singularity determination processor 114 (i.e., singular images) and the knowledge acquisition based on other medical images (i.e., normal images). For example, the knowledge acquisition processor 116 acquires a first medical knowledge based on the singular images and acquires a second medical knowledge based on the normal images. When the normal images are classified into two or more categories, the knowledge acquisition processor 116 can acquire medical knowledge for each of the two or more categories.

The controller 15 stores the medical knowledge acquired by the knowledge acquisition processor 116 in the database 12. With this, the process of the step S8 in FIG. 1 can be implemented.

The right/left determination processor 117 operates when the medical image is an image of a subject's eye and determines whether the medical image is an image of a right eye or an image of a left eye.

When the right/left determination processor 117 is included, the database 12 stores feature information indicating an anatomical feature of an eye in advance. Examples of the anatomical feature of an eye include the location or morphology of optic nerve head, the location or morphology of macula, the distribution or morphology of blood vessels, the distribution or morphology of nerve fibers, and the like. The right/left determination processor 117 analyzes the medical image to determine an interested site(s) (e.g., optic nerve head, macula, blood vessels, nerve fibers). In addition, based on the location of the interested site, the relative location between two or more interested sites, the distribution of the interested sites, or the like, the right/left determination processor 117 determines whether the medical image is a right eye image or a left eye image.

In another example, information indicating that the medical image is a right eye image or a left eye image can be recorded as tag information in a DICOM file, for example. The right/left determination processor 117 can determine whether the medical image is a right eye image or a left eye image by referring to the information.

The artificial intelligence engine 11 can refer to the feature information to execute machine learning, data mining, reasoning, the process of any of the steps in FIG. 1, or the like.

The feature information stored in the database 12 may include right eye information indicating an anatomical feature of a right eye and left eye information indicating an anatomical feature of a left eye. In this case, the artificial intelligence engine 11 can refer to feature information corresponding to the result of determination obtained by the right/left determination processor 117. More specifically, when the medical image is determined to be a right eye image, the artificial intelligence engine 11 can execute machine learning, data mining, reasoning, the process of any of the steps in FIG. 1, or the like based on the right eye information (and other information stored in the database 12). On the other hand, when the medical image is determined to be a left eye image, the artificial intelligence engine 11 can execute machine learning, data mining, reasoning, the process of any of the steps in FIG. 1, or the like based on the left eye information (and other information stored in the database 12).

### EFFECTS

The embodiments described above are configured to classify the medical image into the singular category when the medical image has not been classified properly by the artificial intelligence, like when the classification result of the medical image by the artificial intelligence does not agree with the disease name given by diagnosis etc. In addition, the embodiments described above can collect such exceptional (or singular) medical images and execute machine learning based on the exceptional medical images. With this, machine learning of the artificial intelligence can be performed more effectively than the conventional machine learning in which no attention has been paid to such exceptionality and singularity. As a result, it becomes possible to improve the accuracy and precision of processing executed by the artificial intelligence such as reasoning and data mining.

When the medical image is an image of an eye, the database can store the feature information indicating an anatomical feature of an eye in advance. In addition, the artificial intelligence engine can execute processing (e.g., machine learning, data mining, reasoning) based on the database including the feature information. By referring to such anatomical feature, it becomes possible to further improve the accuracy and precision of processing executed by the artificial intelligence.

When the right/left determination processor configured to determine whether the image of the subject's eye is a right eye image or a left eye image is provided and the feature information includes the right eye information indicating an anatomical feature of a right eye and the left eye information indicating an anatomical feature of a left eye, the artificial intelligence engine can execute processing according to the output from the right/left determination processor. More specifically, the right/left determination processor may be configured to execute processing based on at least the right eye information when the image of the subject's eye is determined to be the right eye image, and execute processing based on at least the left eye information when the image of the subject's eye is determined to be the left eye image. With such a configuration, it becomes possible to further improve the accuracy and precision of processing executed by the artificial intelligence.

Processes included in medical information processing methods according to embodiments are not limited to those in the examples described above. Similarly, components (configuration, actions, operations, etc.) included in medical information processing systems according to embodiments are not limited to those in the examples described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical information processing system comprising an artificial intelligence engine that processes medical information based on a database, the medical information processing system comprising:
a reception unit configured to receive medical information comprising a medical image;
a first classification processor configured to classify, based on the database, the medical image into a category among two or more categories set in advance;
a selection processor configured to select a category among the two or more categories based on the medical information; and
a second classification processor configured to classify the medical image into a singular category when the category determined by the first classification processor and the category determined by the selection processor do not agree with one another.

2. The medical information processing system of claim 1, further comprising a classification adjustment processor configured to adjust an operation parameter of the first classification processor based on a medical image that is classified into the singular category by the second classification processor.

3. The medical information processing system of claim 2, wherein the classification adjustment processor determines a first value of the operation parameter based on the medical image that is classified into the singular category, and a second value of the operation parameter based on a medical image for which the category determined by the first classification processor and the category determined by the selection processor agree with one another.

4. The medical information processing system of claim 1, further comprising a knowledge acquisition processor configured to acquire medical knowledge based on a plurality of medical images that are classified into the singular category by the second classification processor.

5. The medical information processing system of claim 4, wherein the knowledge acquisition processor acquires first medical knowledge based on the medical image that is classified into the singular category, and acquires second medical knowledge based on a medical image for which the category determined by the first classification processor and the category determined by the selection processor agree with one another.

6. The medical information processing system of claim 1, wherein the medical image is an image of a subject's eye.

7. The medical information processing system of claim 6, wherein
the database stores feature information indicating an anatomical feature of an eye in advance, and
the artificial intelligence engine executes processing based on the database comprising the feature information.

8. The medical information processing system of claim 7,
further comprising a right/left determination processor configured to determine whether the image of the subject's eye is a right eye image or a left eye image, wherein
the feature information comprises right eye information indicating an anatomical feature of a right eye and left eye information indicating an anatomical feature of a left eye, and
the artificial intelligence engine executes processing based on at least the right eye information when the image of the subject's eye is determined to be the right eye image, and executes processing based on at least the left eye information when the image of the subject's eye is determined to be the left eye image.

9. A method of processing medical information using a computer comprising an artificial intelligence engine that executes processing based on a database, wherein the computer executes the steps of:
receiving medical information comprising a medical image;
classifying, based on the database, the medical image into a category among two or more categories set in advance;
selecting a category among the two or more categories based on the medical information; and
classifying the medical image into a singular category when the category into which the medical image is classified and the category selected based on the medical information do not agree with one another.
